(19) United States
(12) Patent Application Publication
(10) Pub. No.: US 2006/0077889 A1
(43) Pub. Date: Apr. 13, 2006

(54) Effect analysis apparatus for analyzing network failure

(75) Inventors: Hirohide Kaneko, Kawasaki (JP); Kazuhiro Fujikura, Kawasaki (JP); Hiroshi Yuzawa, Kawasaki (JP)

Correspondence Address: SWIDLER BERLIN LLP, 3000 K STREET, NW, BOX IP, WASHINGTON, DC, 20007, US

(73) Assignee: FUJITSU LIMITED

(21) Appl. No.: 11/107,791

(22) Filed: Apr. 18, 2005

(30) Foreign Application Priority Data
Sep. 28, 2004 (JP) 2004-282843

(51) Int. Cl. H04J 1/16

(52) U.S. Cl. 370/216

(57) ABSTRACT

Information is generated for indicating a virtual path and a line both of which are housed by each real path constituting the communication network, by regarding each of a plurality of routes as a virtual path, and virtual paths housed by a real path which is affected by a network failure is extracted based on this information. Thereby a line housed by one of the virtual paths is extracted, if the extracted plurality of virtual paths identify with combinations of the virtual paths corresponding to the plurality of routes.

### BACKGROUND OF THE INVENTION

1. Field of the Invention

The present invention relates to an effect deployment method for failure in a communication network, particularly to an effect analysis apparatus for identifying customer lines affected by transmission equipment or section failure of a redundantly configured network in a network operation system for managing network transmission equipment, sections, paths and lines of a network.

2. Description of the Related Art

FIG. 1A shows a network operation system of a conventional communication network. The communication network shown by FIG. 1A includes transmission equipment (i.e., nodes) 101 through 106 and sections 1 through 10 are physical paths connecting the transmission equipment. The network operation system 107 comprises an effect analysis apparatus 108 for identifying customer lines affected by transmission equipment or section failures to manage the network.

FIG. 1B exemplifies a conventional effect deployment for a communication network simpler than the one shown by FIG. 1A. A known method is to extract a line affected by a failure by registering in a database the information about a path housed in each section (i.e., logical path) and about a line housed in the path (i.e., logical passing route for data) for extracting the customer line affected by a transmission equipment or section failure.

In an example shown by FIG. 1B, sections 2 and 4 between equipments A and B are configured to provide redundant routes, with the section 2 housing a path 2 and section 4 housing a path 4. Both paths 2 and 4 further house lines 1 and 2. As such, information about the mutual housing relationships between sections, paths and lines are registered in a database.

In this case, the configuration is such that all the lines (i.e., lines 1 and 2) housed in the paths (i.e., paths 2 and 4) which are housed in the dual route sections 2 and 4 are configured to pass through the dual route sections. Therefore, a judgment is made for a dual route stoppage about the sections 2 and 4, and effect deployment for the lower level paths and lines is conducted.

FIG. 1C is a flow chart of such effect deployment processing. When a network failure occurs (Step 111; simply “S111” hereinafter), the effect analysis apparatus 108 first checks the state of the sections (S112) and judges whether or not the stopped section constitutes a dual route (S113). If the stopped section constitutes a dual route, it is then judged if the dual route is stopped (S114), checking the state of the other section constituting the dual route in order to judge whether or not all the routes are stopped (S115). If all the routes are stopped, the effect analysis apparatus 108 searches the housing relationship to extract the path affected by the stop page (S116) and further extracts the line affected thereby (S117). This is used to enable a managing body of the network operation system such as a communications company to notify customers using the stopped line of the stoppage.

Daily development and growth of network configurations, however, have made a network configuration possible as exemplified by FIG. 1D in which each of sections 6 and 8 constitute a dual route between equipment C and D, with the section 6 housing a path 6 and the section 8 housing a path 8. Furthermore, a line 3 is housed in both paths 6 and 8 as a redundant constitution, while a line 4 is housed only in the path 6.

The network configuration shown by FIG. 1D differs from that of the one shown by FIG. 1B is that although line 3 is housed by the dual route as before, the line 4 is housed by a single route in the dual route section. In the case of FIG. 1B, all the lines housed in the dual route section go through the dual route, whereas in the case of FIG. 1D there exists a line housed by a single route, rendering the deployment processing shown by FIG. 1C inappropriate to the network configuration shown by FIG. 1D.

Accordingly, with the sections 6 and 8 being unidentified as a dual route in the database, effect deployment is conducted for the lower level paths and lines rather than the failed section. If another section is defined for a higher level than the extracted line in the same interval with the aforementioned section having failed, the stoppage is regarded as a two-route stoppage and the extracted line is concluded to be under the effect thereof.

FIG. 1E is the flowchart of such an effect analysis process. When a network failure occurs (S121), the effect analysis apparatus 108 first determines the state of the sections (S122), then searches the database (S123) for the paths housed in the stopped section, and further extracts the lines housed in the paths (S124).

Then, extracts the upper level paths from all the extracted lines (S125), and further extracts the upper level sections of the paths by traversing upstream the housing relationship (S126). Then, checks the state of the sections (S127), and judges whether or not all the sections in the same interval as the stopped section are stopped (S128).

If there is another section in the interval with the stopped section, the extracted line is regarded as being stopped (S129). If the other section is not stopped, then the line is regarded as being intact. However, if there is no other section in the interval, it is concluded that the line is passing through only one route of the section and hence that the line is stopped. The processes in the steps 125 through 129 are repeated for all the extracted lines (S130).

The below listed patent document 1 relates to an effect deployment method for identifying lines affected by a path failure in a network operation system, while the patent document 2 relates to protection of virtual paths when a failure occurs in an asynchronous transfer mode network.

[Patent document 1] Japanese registered patent No. 2669328

[Patent document 2] Japanese registered patent No. 3036524

The above described effect deployment processing, however, has issues as follows.

The effect deployment processing shown by FIG. 1E extracts a line by an applying downward effect deployment from the section and further extract all the sections the aforementioned line passes through by going upstream through the housing relationship, thus taking a vast amount of time to identify stopped lines and hence precluding a timely notification to the affected customers.

Furthermore, in the case of the network configuration shown by FIG. 1F, even an effect deployment corresponding to that shown by FIG. 1E precludes a correct effect deployment. A detailed description will be given for effect deployment processing for this case while referring to FIGS. 1G through 1J.

FIG. 1G shows a configuration of an effect analysis apparatus installed with effect deployment processing shown by FIG. 1E. The effect analysis apparatus shown by FIG. 1G comprises an input/output control unit (“I/O control unit” hereinafter) 131, a section state judgment unit 132, a downward deployment unit 133, an upward deployment unit 134, a section state judgment unit 135, a notification unit 136, a section housing table 137, a path housing table 138 and a dual route constitution table 139.

The section housing table 137 stores information about the path housed by each section, the path housing table 138 stores information about the line housed by each path, and the dual route constitution table 139 stores information about the combinations of sections and paths constituting the dual route. For instance, the contents of the section housing table 137, path housing table 138 and dual route constitution table 139 are as shown by FIGS. 1H, 1I and 1J, respectively in the case of network configuration shown by FIG. 1F.

The section housing table shown by FIG. 1H stores information about the paths 1 through 10 housed by the sections 1 through 10 among the equipment A through F, and the path housing table shown by FIG. 1I stores information about the lines housed by the paths 1 through 10. Meanwhile, the dual route constitution table shown by FIG. 1J registers itself with the sections 2 and 7, the sections 3 and 8, the sections 4 and 9, and the sections 5 and 10 as dual routes, respectively.

The I/O control unit 131 transmits and receives information to and from a communication network, the section state judgment unit 132 performs the processing of the step 122, the downward deployment unit 133 performs the processing of the steps 123 and 124, and the upward deployment unit 134 performs the processing of the steps 125 and 126, all shown by FIG. 1E. The section state judgment unit 135 performs the processing of the steps 127 and 128, and the notification unit 136 performs the processing of the step 129.

If a failure occurs in the sections 2 and 8 for instance, the paths 2 and 8 are extracted from the section housing table shown by FIG. 1H, and the lines 1 and 2 are extracted from the path housing table shown by FIG. 1I. Of these, an upward deployment for the line 1 will extract the paths 2 and 8, and further extract the sections 2 and 8.

However, the sections 2 and 7 are recognized as the same interval, and the sections 3 and 8 are recognized as the same interval, whereas the sections 2 and 8 are not recognized as the same interval according to the dual route constitution table shown by FIG. 1J. Because of this, all the sections in the same interval will never be judged to have stopped, hence judging that the line 1 has not stopped in the step 128 shown by FIG. 1E.

As such, a problem occurs where the line 1 is not judged to have stopped according to the effect deployment processing shown by FIG. 1E although the line 1 has actually stopped. In other words, a correct effect deployment may no longer be possible depending on the network configuration.

The above described two problems undermine the relationship of trust between the communication carrier holding and managing the network and customers leasing a line.

### SUMMARY OF THE INVENTION

The challenge of the present invention is to identify correctly and rapidly a customer line affected by a network failure in a network operation system.

An effect analysis apparatus according to the present invention comprises a storage device and a processing device both for identifying a customer line affected by a network failure in a communication network containing a plurality of routes connecting two nodes.

The storage device stores real path constitution information for indicating a virtual path and a line both of which are housed by each real path constituting the communication network, by regarding each of the plurality of routes as a virtual path, virtual path constitution information for indicating a line housed by each virtual path and dual route information for indicating combinations of virtual paths corresponding to the plurality of routes.

The processing device extracts virtual paths housed by a real path affected by the network failure by referring to the real path constitution information and extracting a line housed by one of the extracted plurality of virtual paths by referring to the virtual path constitution information, if the extracted plurality of virtual paths identify with combinations of the virtual paths which are contained in the dual route information.

### BRIEF DESCRIPTION OF THE DRAWINGS

FIG. 1A shows a network operation system;

FIG. 1B shows a first effect deployment;

FIG. 1C shows a flow chart of a first conventional effect deployment;

FIG. 1D shows a second effect deployment;

FIG. 1E shows a flow chart of a second conventional effect deployment;

FIG. 1F shows a flow chart of a third effect deployment;

FIG. 1G shows a configuration of conventional effect analysis apparatus;

FIG. 1H shows a conventional section housing table;

FIG. 1I shows a conventional path housing table;

FIG. 1J shows a conventional dual route constitution table;

FIG. 2A is the principle of effect analysis apparatus according to the present invention;

FIG. 2B shows an effect deployment by using a virtual path;

FIG. 3 shows a configuration of effect analysis apparatus according to the present invention;

FIG. 4 shows a section constitution table;

FIG. 5 shows a path constitution table;

FIG. 6 shows a dual route path judgment table;

FIG. 7 shows a virtual path constitution table;

FIG. 8 is a flow chart of effect deployment processing by using a virtual path;

FIG. 9 shows a configuration of information processing apparatus; and

FIG. 10 shows a method for providing a program and data.

### DESCRIPTION OF THE PREFERRED EMBODIMENTS

A preferred embodiment according to the present invention will be described in detail while referring to the accompanying drawings as follows.

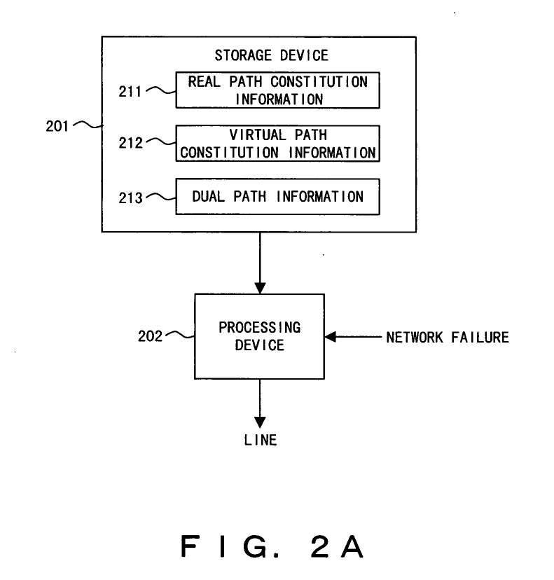

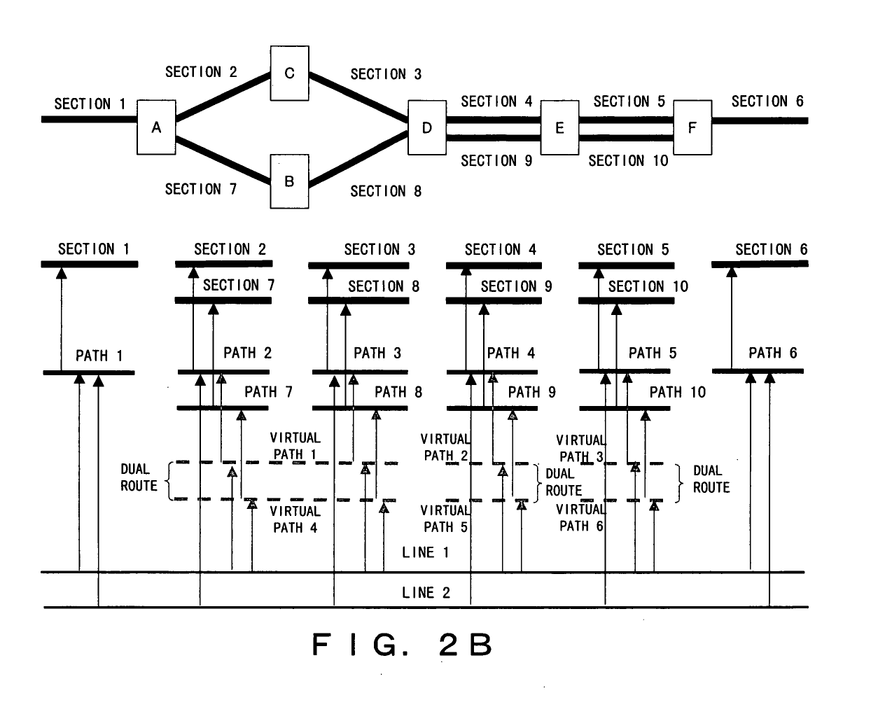

FIG. 2A is the principle of effect analysis apparatus according to the present invention. The effect analysis apparatus shown by FIG. 2A comprises a storage device 201 and processing device 202 both for identifying a customer line affected by a network failure in a communication network containing a plurality of routes connecting two nodes.

The storage device 201 stores real path constitution information 211 for indicating a virtual path housed by each real path constituting a network and a line housed by each real path by regarding each of the plurality of routes as a virtual path, virtual path constitution information 212 for indicating a line housed by each virtual path and dual route information 213 for indicating combinations of virtual paths corresponding to the above described plurality of routes.

The processing device 202 extracts virtual paths housed by a real path being affected by a network failure by referring to the real path constitution information 211 and extracts a line housed by one of the extracted plurality of virtual paths by referring to the virtual path constitution information 212, if the extracted plurality of virtual paths identify with the combinations of virtual paths being contained in the dual route information 213.

Even if one route goes through a plurality of real paths, the route can be related to one virtual path by regarding each of a plurality of routes connecting two nodes as a virtual path. In this case, the real path constitution information 211 for indicating that each of these real paths houses the same virtual paths, respectively, is registered in the storage device 201.

It is possible to judge whether or not a plurality of routes between two nodes have all stopped by extracting virtual paths housed by a real path affected by a network failure from such a real path constitution information 211, and by comparing the extracted plurality of virtual paths with the combinations of virtual paths contained in the dual route information 213. If the extracted plurality of virtual paths identify with the combinations of virtual paths, the judgment is that all the routes are stopped, thus extracting the line housed by the stopped virtual path as the stopped line according to the virtual path constitution information 212.

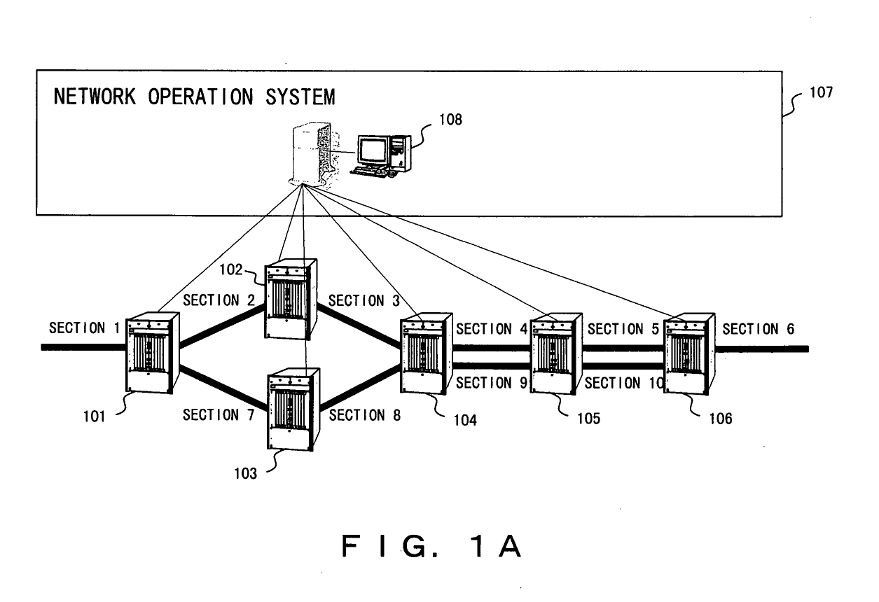

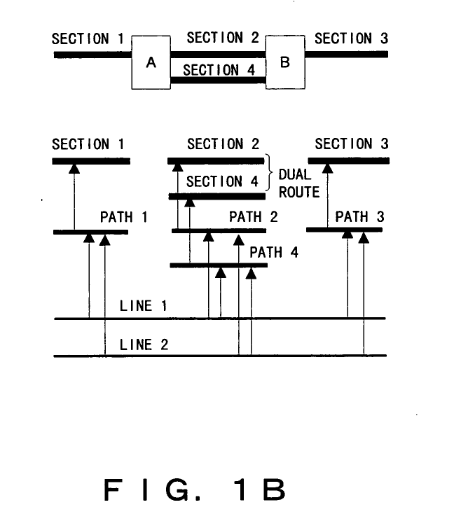

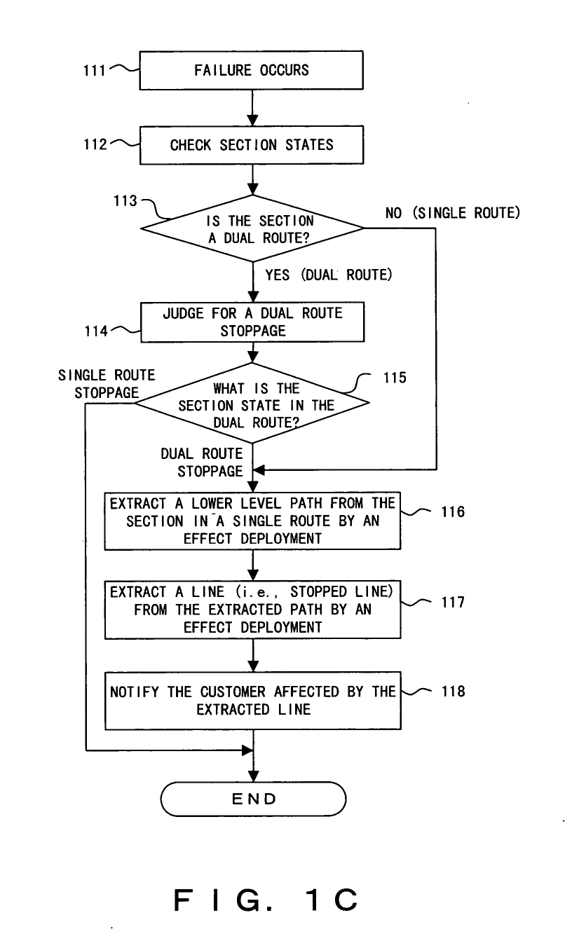

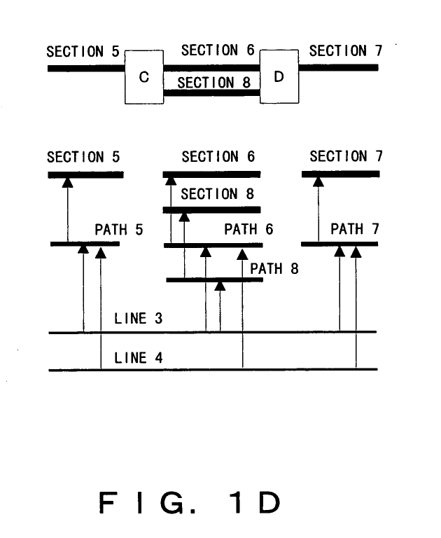

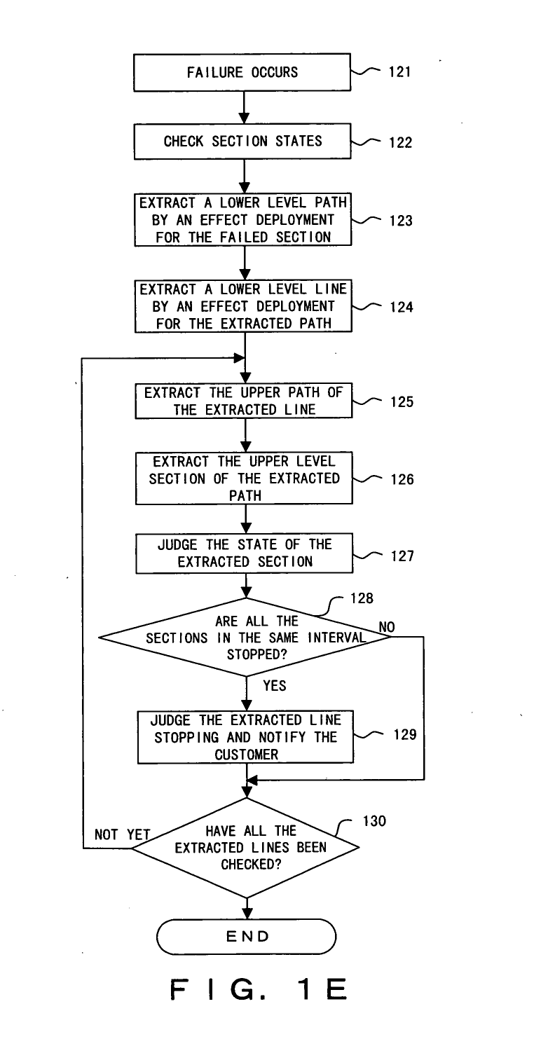

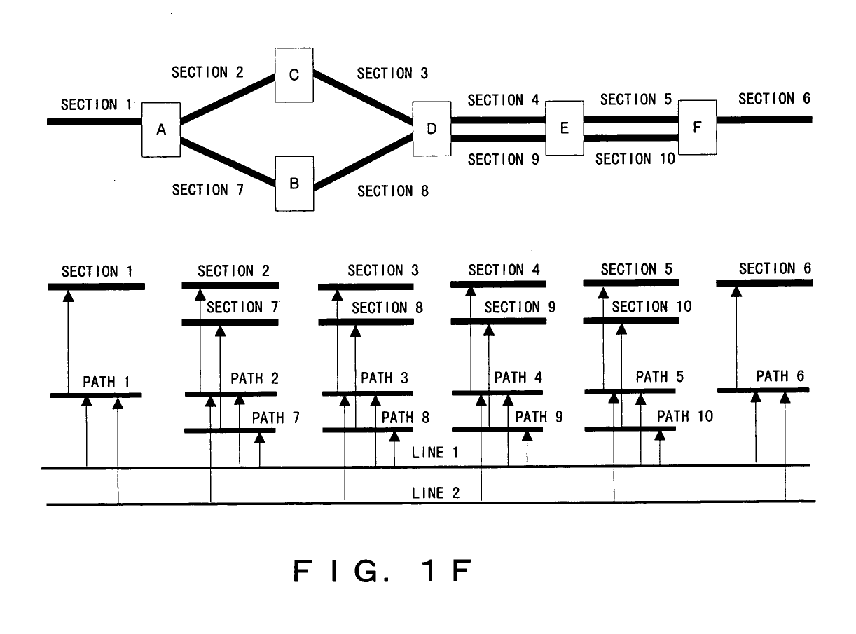

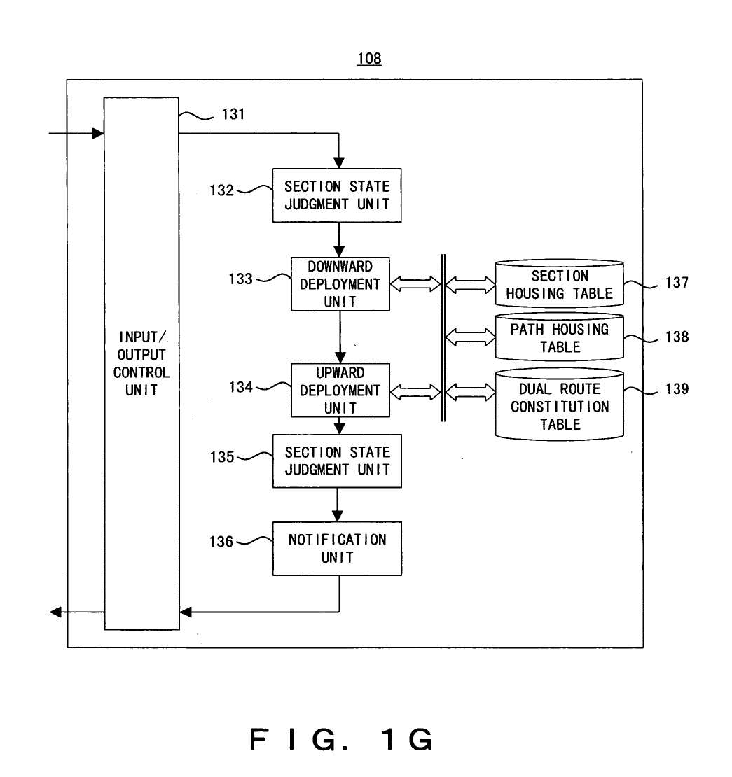

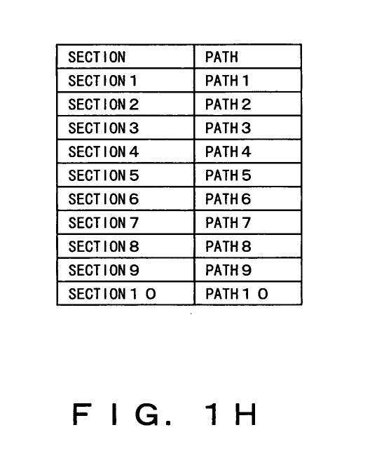

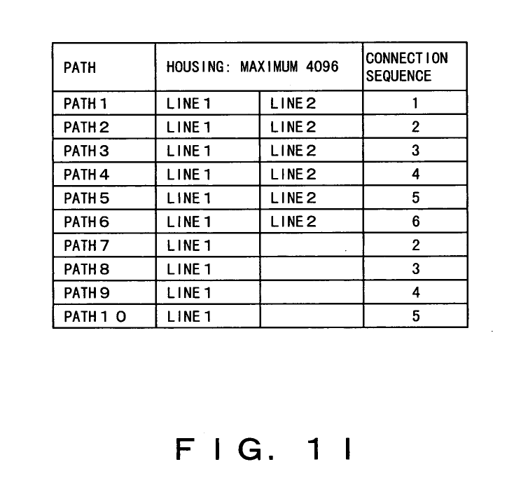

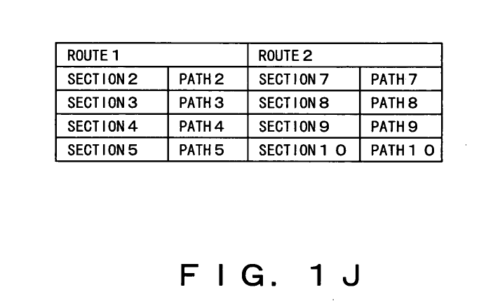

An effect analysis apparatus configured in such a way makes it possible to identify the line affected by a network failure correctly even for the network shown by FIG. 1F, by regarding each of a plurality of routes connecting two nodes as a virtual path; and enables high speed processing since there is no need for conducting an upward effect deployment.

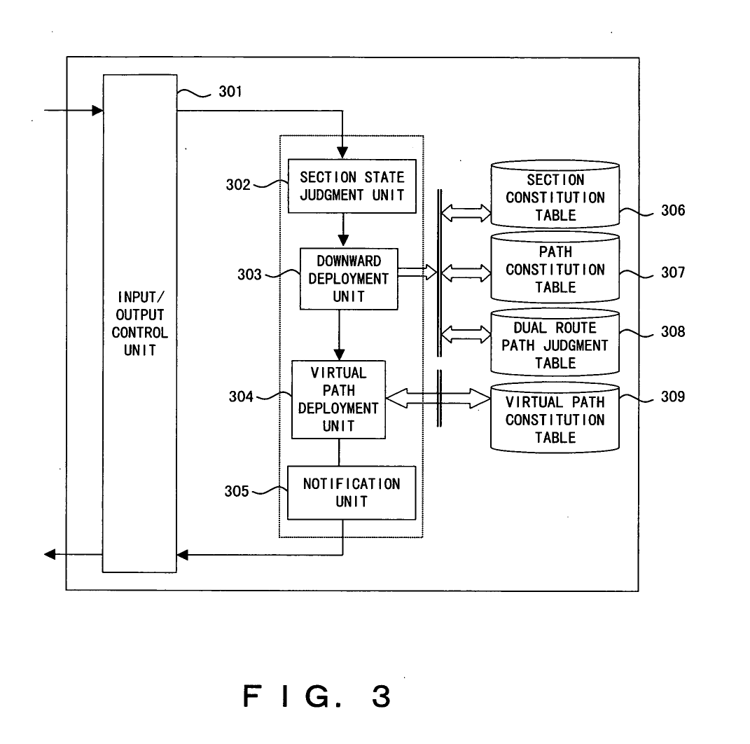

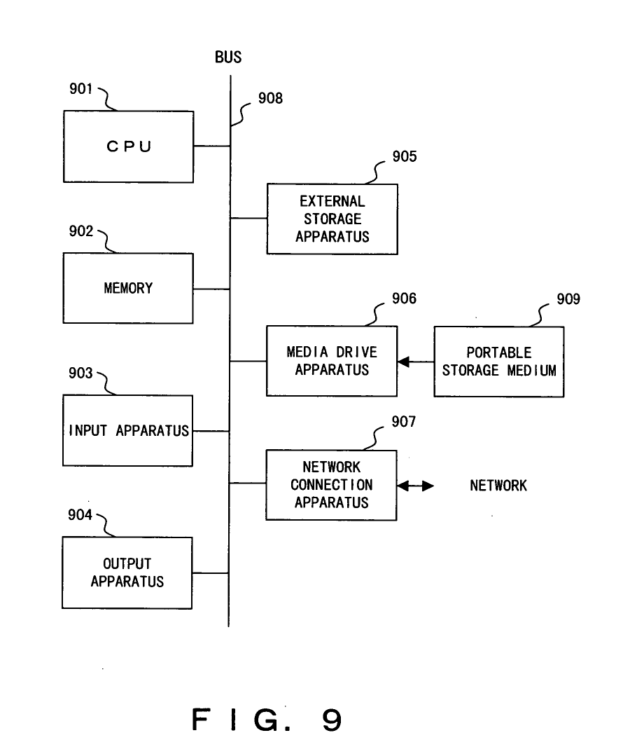

The storage device 201 corresponds to a later described memory 902 or external storage apparatus 905 both shown by FIG. 9 for instance, and the processing device 202 corresponds to a CPU (Central Processing Unit) 901 shown by FIG. 9 for instance. Meanwhile, the real path constitution information 211, virtual path constitution information 212 and dual route information 213 correspond to later described path constitution table 307, virtual path constitution table 309 and dual route constitution table 308, respectively, shown by FIG. 3.

The present invention enables the network managing body to identify correctly and rapidly the customer lines affected by a network failure when the failure occurs and thus to take appropriate action for the customer.

The present embodiment introduces the concept of a virtual path which is housed under the control of the section and manages the virtual paths by using a database in order to conduct an accurate effect deployment at the time of a failure occurrence. In the case of one route going through a plurality of real paths, the combination of the real paths is defined as one virtual path and it is registered in the database as housed by the real paths.

FIG. 2B exemplifies the network configuration shown by FIG. 1F introducing virtual path management therein. In the example shown by FIG. 2B, the virtual path 1 is housed by the paths 2 and 3; the virtual path 4 is housed by the paths 7 and 8; and the virtual paths 2, 3, 5 and 6 are housed by the paths 4, 5, 9 and 10, respectively. The virtual paths 1 and 4, 2 and 5, and 3 and 6 are defined as constituting dual routes respectively.

If a line housed by a real path in the case of FIG. 1F goes through a dual route constituted by two virtual paths in the case of FIG. 2B, the line is registered as being housed by both of the virtual paths. However, if such a line goes through a single path of the virtual path, the line is registered as being housed by the real path. Therefore, the line 1 is registered as being housed by the virtual paths 1 through 6 while the line 2 is not housed by any of the virtual paths.

Managing such virtual paths makes it possible to define an accurate route configuration and thereby conduct a judgment of dual route stoppage in a hierarchy of virtual paths. Also, registering only a line going through a dual route for the virtual path constituting the dual route eliminates the need for searching upstream through the housing relationship as in the effect deployment processing shown by FIG. 1E, thereby speeding up the effect deployment processing greatly.

FIG. 3 shows a configuration of effect analysis apparatus according to the present embodiment. The effect analysis apparatus shown by FIG. 3 comprises an input/output control unit 301, a section state judgment unit 302, a downward deployment unit 303, a virtual path deployment unit 304, a notification unit 305, a section constitution table 306, a path constitution table 307, a dual route path judgment table 308 and a virtual path constitution table 309.

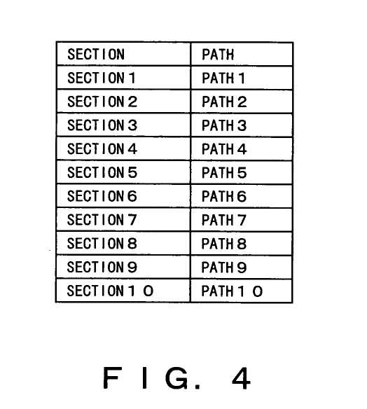

The section constitution table 306 stores the information about the paths housed by each section; the path constitution table 307 stores the information about the virtual paths and the lines both housed by each path; the dual route path judgment table 308 stores the information for indicating the combinations of virtual paths constituting a dual route; and the virtual path constitution table 309 stores the information about the lines stored by each virtual path. In the network configuration shown by FIG. 2B, the contents of the section constitution table 306, path constitution table 307, dual route path judgment table 308 and virtual path constitution table 309 are the ones as shown by FIGS. 4, 5, 6 and 7, respectively, for example.

The content of the section constitution table shown by FIG. 4 is the same as that of the section housing table shown by FIG. 1H. In this example there are two routes between the nodes A and D, i.e., one going through the section 2, node C and section 3; and the other going through the section 7, node B and section 8. The section constitution table shown by FIG. 4 is registered by the sections 2, 3, 7 and 8 housing the paths 2, 3, 7 and 8, respectively.

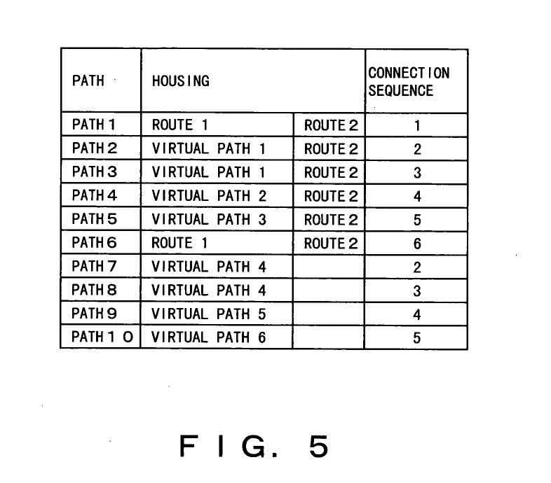

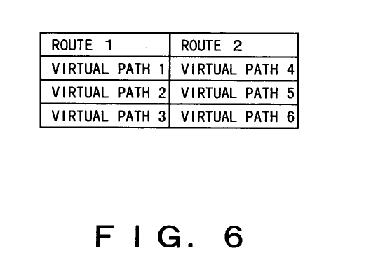

The path constitution table shown by FIG. 5 is registered so as to specify that the paths 2 and 3 both house the virtual path 1 and the line 2, and the paths 7 and 8 both house the virtual path 4. The dual route path judgment table shown by FIG. 6 is registered to specify the virtual paths 1 and 4 constituting a dual route. Likewise, there are dual routes between the nodes D and E, and between the nodes E and F, therefore the virtual paths 2 and 5, and the virtual paths 3 and 6 are registered as dual routes.

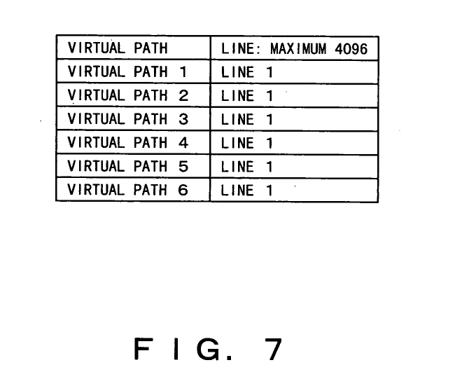

Since the line 1 passes through all these three pairs of dual routes, the virtual path constitution table shown by FIG. 7 is registered to specify all the virtual paths housing the line 1. Contrarily the line 2 only passes through a single route; therefore the virtual path constitution table shown by FIG. 7 is not registered by the line 2. Instead, the path constitution table shown by FIG. 5 is registered to specify the paths 2, 3, 4 and 5 housing the line 2.

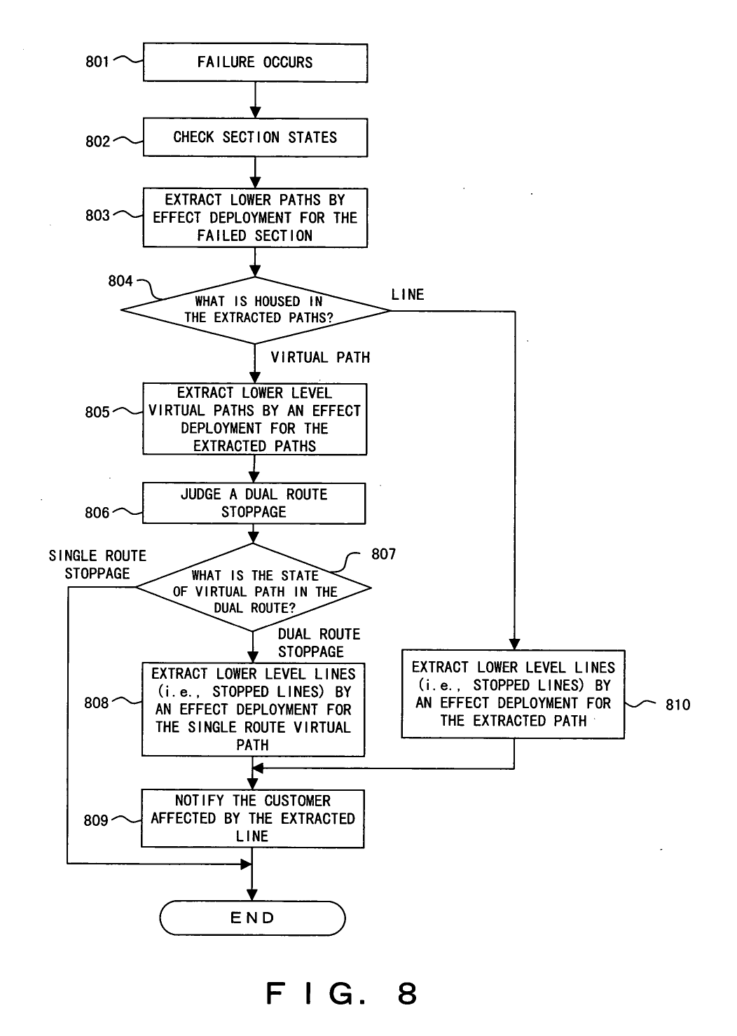

FIG. 8 is a flow chart of effect deployment processing performed by the effect analysis apparatus shown by FIG. 3. When a network failure occurs (S801), the section state judgment unit 302 first determines the states of the sections to identify the stopped section (S802).

If the failure has occurred in the sections 2 and 8 for instance, checking the states of the sections can identify the sections 2 and 8 being stopped.

Then, the downward deployment unit 303 extracts the paths housed by the stopped sections by referring to the section constitution table 306 (S803), and checks as to which of a virtual path or a line is housed by the extracted path by referring to the path constitution table 307 (S804).

The section constitution table shown by FIG. 4 makes it possible to identify the paths 2 and 8 being housed by the stopped sections 2 and 8, respectively. Meanwhile, the path constitution table shown by FIG. 5 indicates that the virtual path 1 and the line 2 are housed by the path 2; and that the virtual path 4 are housed by the path 8.

If the extracted path houses a virtual path, the downward deployment unit 303 extracts the virtual path from the section constitution table 306 (S805), determines a dual route stoppage by referring to the dual route path judgment table 308 (S806), and determines whether or not all the routes have been stopped by checking the states of all the virtual paths constituting the dual route (S807).

The dual route path judgment table shown by FIG. 6 makes it possible to identify the virtual paths 1 and 4 constituting a dual route, and to further determine a dual route stoppage of a virtual path, since both the routes have been stopped.

If a dual route is stopped, the virtual path deployment unit 304 extracts the line housed by one virtual path constituting the stopped dual route by referring to the virtual path constitution table 309 (S808). Then the notification unit 305, recognizing the stoppage of the extracted line, notifies the customer subscribing to the line, of a line stoppage (S809). On the other hand, if the single route alone is stopped, the processes of the steps 808 and 809 will not be executed.

The virtual path constitution table shown by FIG. 7 lets it identify the virtual path 1 housing the line 1, thereby judging the line 1 to be stopped and accordingly notifying the customer of the line 1 of the failure.

Meanwhile, if the checking in the step 804 has identified that the extracted path houses a line, the downward deployment unit 303 extracts the line from the section constitution table 306 (S810). Then the notification unit 305 notifies the customer of the line of the line stoppage (S809).

Since the path constitution table shown by FIG. 5 allows the extraction of the line 2, judging the line 2 to be stopped and accordingly notifying the customer of the line 2 of the stoppage.

While the above described example describes the case of the sections 2 and 8 being stopped, if the section 2 alone is stopped, the step 803 allows the effect deployment process to extract the line 2, the step 805 extracts the virtual path 1, the step 810 extracts the line 2, thus the line 2 is judged to be stopped and the step 807 determines that there is a single route stoppage since only one of the virtual paths constituting the dual route is stopped, thus the line 1 is judged to be operational.

As described above, the effect deployment processing shown by FIG. 8 makes it possible to identify accurately lines stopped by a network failure for the network configuration shown by FIG. 1F. Also, only judgment for dual route stoppage by using virtual paths can identify the stopped line, eliminating the need for upward deployment and hence enabling high speed effect deployment processing.

For instance, in the case of effect deployment processing shown by FIG. 1C, assuming there are a maximum of 4096 lines under one path, 4096 judgments are needed when examining the housing relationship of the 4096 lines in the upstream direction. Whereas the effect deployment shown by FIG. 8 only requires the judgment of dual route stoppage by using the virtual paths to extract the affected line, hence gaining an advantage of a reduction of a maximum of 4096 judgments.

Incidentally, the effect analysis apparatus shown by FIG. 3 is comprised by using an information processing apparatus (i.e., computer) as shown by FIG. 9 for example. The information processing apparatus shown by FIG. 9 comprises a CPU (Central Processing Unit) 901, memory 902, an input apparatus 903, an output apparatus 904, an external storage apparatus 905, a media drive apparatus 906 and network connection apparatus 907, with a bus 908 interconnecting the aforementioned components.

The memory 902, comprising ROM (Read Only Memory), RAM (Random Access Memory), et cetera, for example, stores the program and data used for the processing. The CPU 901 performs effect deployment processing by executing the program by using the memory 902.

The section state judgment unit 302, the downward deployment unit 303, the virtual path deployment unit 304 and the notification unit 305 all shown by FIG. 3 correspond to the program stored in the memory 902; and the section constitution table 306, the path constitution table 307, the dual route path judgment table 308 and the virtual path constitution table 309 correspond to data stored in the memory 902.

The input apparatus 903, comprising a keyboard, a pointing device, a touch panel, et cetera, for example, are used for the input of operator instructions, or information. The output apparatus, comprising a display, a printer, speakers, et cetera, for example, are used to out put an inquiry to the operator, a processing result, et cetera.

The external storage apparatus 905 comprises a magnetic disk, optical disk, magneto optical disk or magnetic tape apparatuses, et cetera, for example. The information processing apparatus stores the program and data in the external storage apparatus and uses the program and data by loading them into the memory 902 as required. The external storage apparatus 905 is also used for the database for storing the section constitution table 306, the path constitution table 307, the dual route path judgment table 308 and the virtual path constitution table 309.

The media drive apparatus 906 drives a portable storage medium 909 for accessing the contents stored therein. The portable storage medium 909 is a discretionary computer readable storage medium compatible with a memory card, a flexible disk, an optical disk, a magneto optical disk, et cetera. The operator stores the program and data in the portable storage medium 909 for use by loading them into the memory 902 as required.

The network connection apparatus 907, corresponding to the I/O control unit 301 shown by FIG. 3, exchanges data in association with communications. The information processing apparatus sometimes receives the program and data from an external apparatus by way of the network connection apparatus 907 to load into the memory 902.

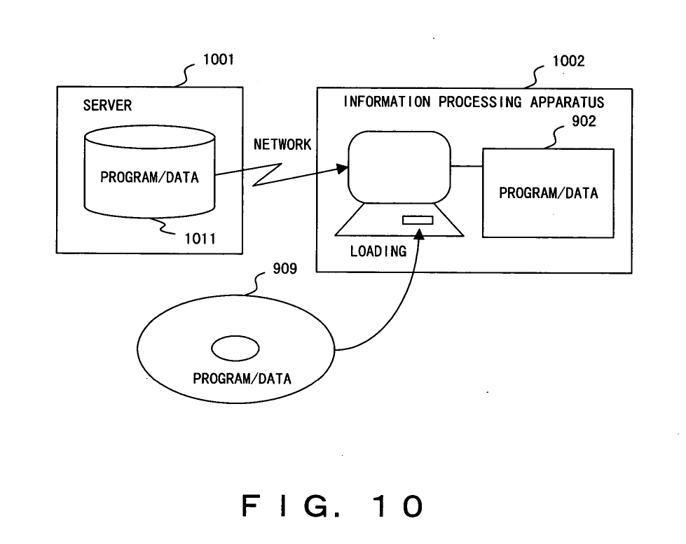

FIG. 10 shows a method for providing a program and data to the information processing apparatus shown by FIG. 9. The program and data stored in a database 1011 comprised by a portable storage medium 909 or a server 1001 is loaded into the memory 902 comprised by the information processing apparatus 1002. The server 1001 generates a carrier signal for carrying the program and data and transmits them to the information processing apparatus 1002 by way of an arbitrary transmission media on the network. The CPU 901 executes the program by using the data to perform effect deployment processing.

1. An effect analysis apparatus for identifying a customer line affected by a network failure in a communication network including a plurality of routes connecting two nodes, comprising:
a storage unit for storing real path constitution information for indicating a virtual path and a line both of which are housed by each real path constituting the communication network, by regarding each of the plurality of routes as a virtual path, virtual path constitution information for indicating a line housed by each virtual path and dual route information for indicating combinations of virtual paths corresponding to the plurality of routes; and
a processing unit for extracting virtual paths housed by a real path being affected by network failure by referring to the real path constitution information and extracting a line housed by one of the extracted plurality of virtual paths by referring to the virtual path constitution information, if the extracted plurality of virtual paths identify with the combinations of the virtual paths which are contained in the dual route information.

2. An effect analysis apparatus for identifying a customer line affected by a network failure in a communication network including a plurality of routes connecting two nodes, comprising:
a storage device for storing real path constitution information for indicating a virtual path and a line both of which are housed by each real path constituting the communication network, by regarding each of the plurality of routes as a virtual path; and
a processing device for extracting a line housed by a real path being affected by the network failure by referring to the real path constitution information.

3. The effect analysis apparatus according to claim 1, further comprising a notification device for notifying the customer of an extracted line of a line stoppage.

4. A computer readable storage medium storing a program for a computer for identifying a customer line affected by a network failure in a communication network including a plurality of routes connecting two nodes, wherein the program allows the computer to execute the processes of extracting virtual paths housed by a real path being affected by the network failure by reading, from a storage device, real path constitution information for indicating a virtual path and a line both of which are housed by each real path constituting the communication network, by regarding each of the plurality of routes as a virtual path;
reading, from the storage device, dual route information for indicating combinations of virtual paths corresponding to the plurality of routes; and
extracting a line housed by one of the extracted plurality of virtual paths by reading, out of the storage device, virtual path constitution information for indicating a line housed by each virtual path, if the extracted plurality of virtual paths identify with the combinations of virtual paths.

5. The storage medium according to claim 4, wherein said real path constitution information indicates that a line going through only one of said plurality of routes is stored by a real path, and said virtual path constitution information indicates that a line going through the plurality of routes is housed by all virtual paths being contained in the combinations of virtual paths.

6. A computer readable storage medium storing a program for a computer for identifying a customer line affected by a network failure in a communication network including a plurality of routes connecting two nodes, wherein the program makes the computer execute the processes of
extracting a line housed by a real path being affected by the network failure by reading, from a storage device, real path constitution information for indicating a virtual path and a line both of which are housed by each real path constituting the communication network, by regarding each of the plurality of routes as a virtual path.

7. The storage medium according to claim 4, wherein said program allows said computer to execute a process of notifying the customer of an extracted line of a line stoppage.

8. The storage medium according to claim 4, wherein said real path constitution information indicates that each of a plurality of real paths houses a virtual path, if the virtual path corresponds to a route going through the plurality of real paths.

9. An effect analysis method for identifying a customer line affected by a network failure in a communication network including a plurality of routes connecting two nodes, comprising the steps of
storing real path constitution information for indicating a virtual path and a line both of which are housed by each real path constituting the communication network, by regarding each of the plurality of routes as a virtual path, virtual path constitution information for indicating a line housed by each virtual path and dual route information for indicating combinations of virtual paths corresponding to the plurality of routes; and
extracting virtual paths housed by a real path being affected by the network failure by referring to the real path constitution information and extracting a line housed by one of the extracted plurality of virtual paths by referring to the virtual path constitution information, if the extracted plurality of virtual paths identify with the combinations of the virtual paths which are contained in the dual route information.

10. An effect analysis method for identifying a customer line affected by a network failure in a communication network including a plurality of routes connecting two nodes, comprising the steps of
storing real path constitution information for indicating a virtual path and a line both of which are housed by each real path constituting the communication network, by regarding each of the plurality of routes as a virtual path; and
extracting a line housed by a real path being affected by the network failure by referring to the real path constitution information.

11. The effect analysis method according to claim 9, wherein the customer of an extracted line is notified of a line stoppage.

12. A carrier signal for carrying a program for a computer for identifying a customer line affected by a network failure in a communication network including a plurality of routes connecting two nodes, wherein the program makes the computer execute the processes of extracting virtual paths housed by a real path affected by the network failure by reading, from a storage device, real path constitution information for indicating a virtual path and a line both of which are housed by each real path constituting the communication network, by regarding each of the plurality of routes as a virtual path;
reading, out of the storage device, dual route information for indicating combinations of virtual paths corresponding to the plurality of routes; and
extracting a line housed by one of the extracted plurality of virtual paths by reading, from the storage device, virtual path constitution information for indicating a line housed by each virtual path, if the extracted plurality of virtual paths identify with the combinations of virtual paths.

13. A carrier signal for carrying a program for a computer for identifying a customer line affected by a network failure in a communication network including a plurality of routes connecting two nodes, wherein the program allows the computer to execute the processes of
extracting a line housed by a real path being affected by the network failure by reading, from a storage device, real path constitution information for indicating a virtual path and a line both of which are housed by each real path constituting the communication network, by regarding each of the plurality of routes as a virtual path.

14. An effect analysis apparatus for identifying a customer line affected by a network failure in a communication network including a plurality of routes connecting two nodes, comprising:
a storage unit for storing real path constitution information for indicating a virtual path and a line both of which are housed by each real path constituting the communication network, by regarding each of the plurality of routes as a virtual path, virtual path constitution information for indicating a line housed by each virtual path and dual route information for indicating combinations of virtual paths corresponding to the plurality of routes; and
a processing unit for extracting virtual paths housed by a real path affected by the network failure by referring to the real path constitution information and extracting a line housed by one of the extracted plurality of virtual paths by referring to the virtual path constitution information, if the extracted plurality of virtual paths identify with the combinations of the virtual paths which are contained in the dual route information.

15. An effect analysis apparatus for identifying a customer line affected by a network failure in a communication network including a plurality of routes connecting two nodes, comprising:
a storage unit for storing real path constitution information for indicating a virtual path and a line both of which are housed by each real path constituting the communication network, by regarding each of the plurality of routes as a virtual path; and
a processing unit for extracting a line housed by a real path being affected by the network failure by referring to the real path constitution information.
